(19) United States
(12) Patent Application Publication
(10) Pub. No.: US 2005/0204838 A1
(43) Pub. Date: Sep. 22, 2005

(54) Multi-speed automatic layshaft transfer case

(76) Inventor: Monica DeGraffenreid, Westland, MI (US)

Correspondence Address: MACMILLAN, SOBANSKI & TODD, LLC, ONE MARITIME PLAZA - FOURTH FLOOR, 720 WATER STREET, TOLEDO, OH, 43604, US

(21) Appl. No.: 10/804,423

(22) Filed: Mar. 19, 2004

(51) Int. Cl. F16H 3/44

(52) U.S. Cl. 74/329; 74/333

(57) ABSTRACT

A power transfer mechanism includes an input, first and second outputs, a synchronizer for releaseably connecting the input and first output, a speed reduction drive path for driving the first output at a lower speed than a speed of the input including a pinion secured to the input, a gear journalled on the layshaft and driveably engaged with the pinion, a second pinion journalled on the layshaft, a second gear secured to the first output and driveably engaged with the second pinion, a first clutch for releasably connecting the first gear and the second pinion, and a second clutch for releasably connecting the second gear and the transfer drive. The coupler may be a synchronizer clutch or a dog clutch.

### BACKGROUND OF THE INVENTION

This invention relates to the field of transfer drive mechanisms, particularly to motor vehicle transfer cases for transmitting power to a driveshaft in a four-wheel drive or all wheel drive system.

Conventional, commercially available multi-speed transfer cases are long, heavy, and high cost gearboxes having limited functionality. For example, most transfer cases require the vehicle to come to a stop before switching between a high-speed range and a low speed range. This is often inconvenient to the operator.

Various transfer case having synchronized layshaft-type range shifting, hydraulic range shifting, adaptive clutch controls, and full-time four-wheel drive capability with a limited slip clutch are known in the prior art.

However there is a need for a compact transfer case having a relatively short axial length, whose manufacturing and assembly costs are low, and capable of producing smooth shifts when shifting between a low speed range and a high-speed range. Preferably, such a transfer case would include a coupler or synchronizer for switching between the high-speed and low-speed ranges, and a simple layshaft gear arrangement for producing multiple speeds. Ideally, such a transfer case would provide for a park mechanism located within the transfer case and capable of holding the output fixed against rotation without need for hydraulic pressure.

### SUMMARY OF THE INVENTION

An advantage of the present invention is the compact size of the transfer case and its ability to produce multiple speed ranges in both 4×2 and 4×4 modes of operation. Due to its use of a layshaft speed reduction gear train and a coupler or synchronizer for switching between the high-speed and low-speed ranges, manufacturing and assembly cost is low. Due to an integrated assembly of gears and hydraulically actuated clutches and their unique arrangement, vehicle noise, vibration and harshness (NVH) are improved.

Power transfer shift feel is enhanced due use of a multi-plate, hydraulic clutch in the low-speed ranges, which allows for finer shift control when shifting between low and high ranges.

Because the transfer case is compact for its multiple speed range function, the vehicle level powertrain bending displacements are improved. In addition, because the overall length is short and it size is compact compared to current conventional transfer case systems, NVH is further improved and the number of components is kept low.

It is yet another advantage of the invention that the output shaft can be fixed against rotation by a park mechanism located within the transfer case because the coupler or synchronizer clutch is spring-loaded to produce a direct connection between the output shaft and transmission shaft. Hydraulic pressure is not required to complete this connection. A high flow rate variable force solenoid can be used to hydraulically engage the coupler or synchronizer in the high-speed range.

In realizing these advantages, a transfer case according to this invention includes a power transfer mechanism comprising an input, a first output coaxial with the input, a speed reduction drive path driveably connected to the input and first output, for driving the first output at a slower speed than a speed of the input, a coupler for releaseably connecting the input and first output, a second output, a transfer drive having a first sprocket wheel rotatably supported on the first output, a second sprocket wheel secured to the second output, and a drive chain driveably engaged with the first sprocket wheel and the second sprocket wheel, and a clutch for releaseably connecting the speed reduction drive path and the first sprocket wheel.

Various objects and advantages of this invention will become apparent to those skilled in the art from the following detailed description of the preferred embodiment, when read in light of the accompanying drawings.

### BRIEF DESCRIPTION OF THE DRAWINGS

FIG. 1 is a top view of a motor vehicle driveline having a transmission, transfer case, and drive shafts extending to front wheels and rear wheels;

FIG. 2 is a schematic diagram of a kinematic arrangement for a transfer case according to this invention;

FIG. 3 is a chart showing the state of engagement and disengagement of the coupler and clutches of the arrangement of FIG. 2;

FIG. 4 is a schematic diagram of an alternate kinematic arrangement for a transfer case according to this invention;

FIG. 5 is a chart showing the state of engagement and disengagement of the coupler and clutch of the arrangement of FIG. 4; and

FIG. 6 is a cross section of a transfer case assembly corresponding to the arrangement of FIG. 2.

### DETAILED DESCRIPTION OF THE PREFERRED EMBODIMENT

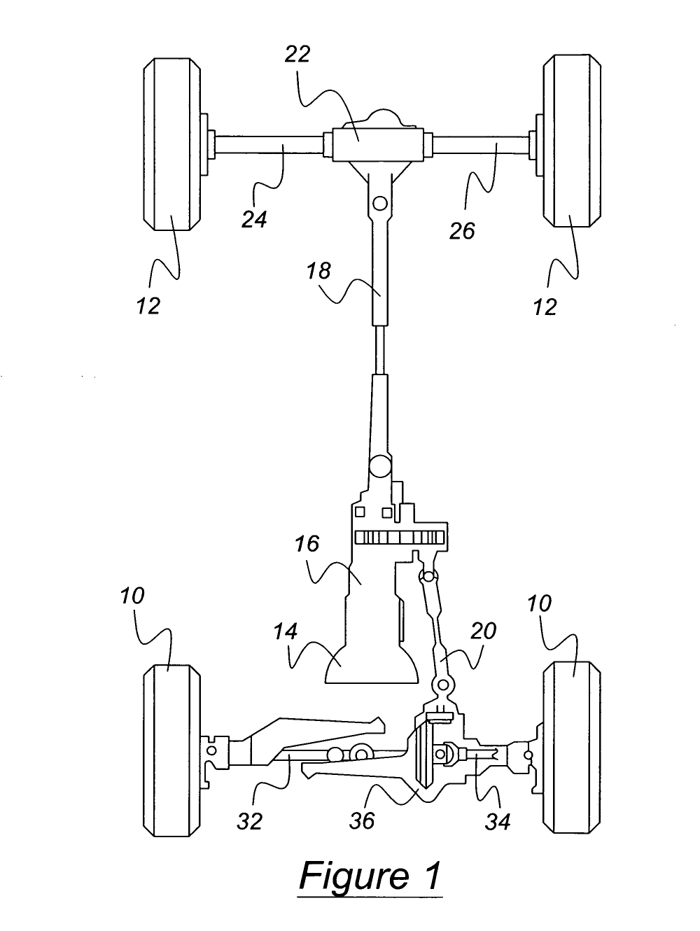

With reference now to the drawings and particularly to FIG. 1, the powertrain of a motor vehicle, to which the present invention can be applied, includes front and rear wheels 10, 12, a power transmission 14 for producing multiple forward and reverse speed ratios driven by an engine (not shown), and a transfer case 16 for continuously driveably connecting the transmission output to a rear drive shaft 18. The transfer case 16 selectively connects the transmission output to both the front drive shaft 20 and rear drive shaft 18 when a four wheel drive mode of operation is selected, either manually or electronically. Shaft 18 transmits power to a rear wheel differential mechanism 22, from which power is transmitted differentially to the rear wheels 12 through axle shafts 24, 26, which are contained within a differential housing. The front wheels are driveably connected to right-hand and left-hand axle shafts 32, 34, to which power is transmitted from the front drive shaft 20 through a front differential mechanism 36.

It should be appreciated that the terms “front” and “rear” are used herein for convenience purposes only, to refer to a secondary and primary driveshafts, respectively. In alternate embodiments of the invention, the front and rear driveshafts may be interchanged, e.g., the front driveshaft may act as the primary driveshaft.

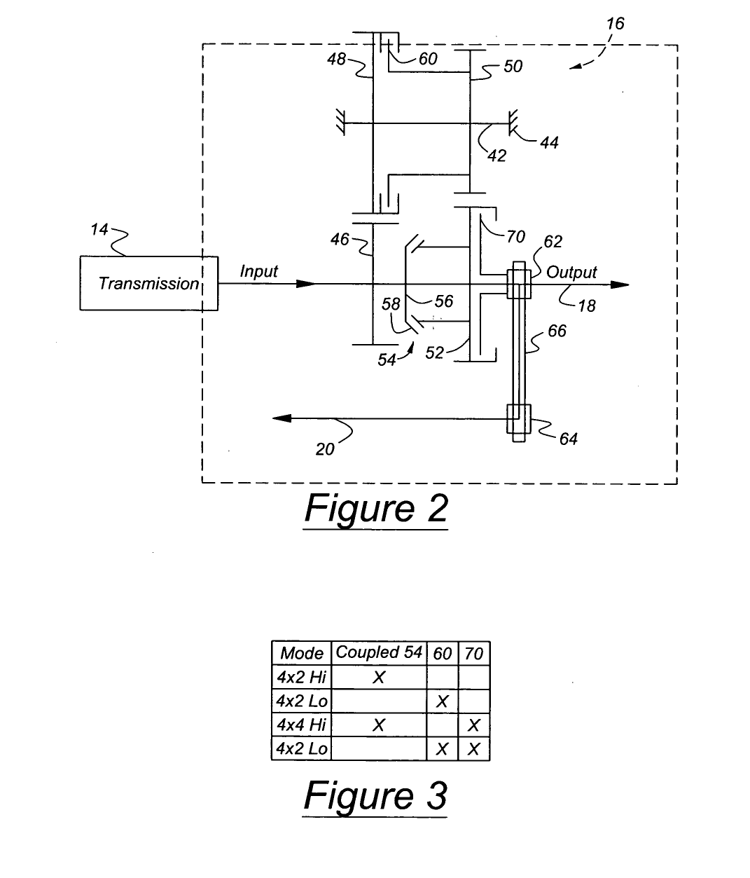

Referring now to FIG. 2, the transfer case 16 includes input 40, a first output 18, and a second output 20. The input 40 is driveably connected to the output of a transmission 14, which is driven by an engine or motor (not shown). The first transfer case output 18 is driveably connected to rear drive shaft 18 and is aligned coaxially with input 40. The second output 20 is driveably connected to the front drive shaft and extends from the transfer case 16 forward to the front drive axles of the vehicle.

The drive mechanism includes a speed reduction drive path located between the input 40 and first output 18. A lay shaft 42, arranged substantially parallel to the input 40 and first output 18, is supported on the walls or another structural component 44 of the transfer case. A pinion 46, secured to input 40, is in continuous meshing engagement with a gear 48, journalled on lay shaft 42. Gear 48 rotates at a slower speed than the speed of the input and pinion 46. Another pinion 50, journalled on lay shaft 42 adjacent gear 48, is in continuous meshing engagement with a gear 52, which is secured to the first output 18.

A coupler 54, which may be a synchronizer or a dog clutch, includes a hub 56 secured to input 40. The hub 56 is formed at the radially outer surface with axially-directed spline teeth, which are engaged by complementary spline teeth formed on the radially inner surface of a displaceable sleeve 58 carried on hub 56. Gear 52 carries dog teeth, which are sized, spaced and aligned with the spline teeth on the sleeve 58, so that, when sleeve 58 moves rightward from the position shown in FIG. 2, the spline teeth on the sleeve engage the dog teeth on the gear. This engagement directly, driveably connects the input 40 and the first output 18.

Preferably, sleeve 58 is continually biased by a spring into engagement with gear 52. The sleeve is disengaged from gear 52 by an actuator that moves sleeve 58 leftward and permits it to move rightward in accordance with the pressurized and vented state of the actuator. Preferably, the actuator is hydraulically actuated.

Gear 48 is releaseably connected to pinion 50 through operation of a hydraulically actuated friction clutch 60.

The first output 18 is secured to a first sprocket wheel 62, which is aligned axially with a second sprocket wheel 64, secured to the second output 20. A drive chain 66, which transmits power between the first output 18 and the second output 20, engages teeth formed on the outer radial surface of the sprocket wheels 62, 64. Sprocket wheel 62 is releaseably connected to gear 52 through operation of a hydraulically actuated friction clutch 70.

Referring now to FIG. 3, the transfer case produces a high-speed range in the 4×2 mode by engaging coupler 54 and disengaging clutches 60 and 70. When coupler 54 is engaged, sleeve 58 moves rightward to engage gear 52. This directly driveably connects input 40 to the first output 18.

Disengaging coupler 54 and engaging clutch 60 produces a 4×2 mode, low-speed range. This action causes pinion 46 to underdrive gear 48 and pinion 50, which is driveably connected through clutch 60 to gear 48. Pinion 50 underdrives gear 52 and first output 18, to which gear 52 is secured. In this way, the output 18 is underdriven in relation to the speed of input 40.

Engaging coupler 54 and clutch 70 and disengaging clutch 60 produces a 4×4 mode, high-speed range. This action causes input 40 to be directly connected through coupler 54 to the first output 18 and gear 52. Clutch 70 driveably connects gear 52 and the first output 18 to the second output 20, through the drive mechanism that includes sprocket wheels 62, 64 and drive chain 66.

Engaging clutches 60 and 70 and disengaging coupler 54 produces a 4×4 mode, low-speed range. This underdrives gear 52 and first output 18 in relation to the speed of input 40 through the lay shaft speed reduction mechanism and clutch 60. Clutch 70 driveably connects the second output 20 to the first output 18 and gear 52.

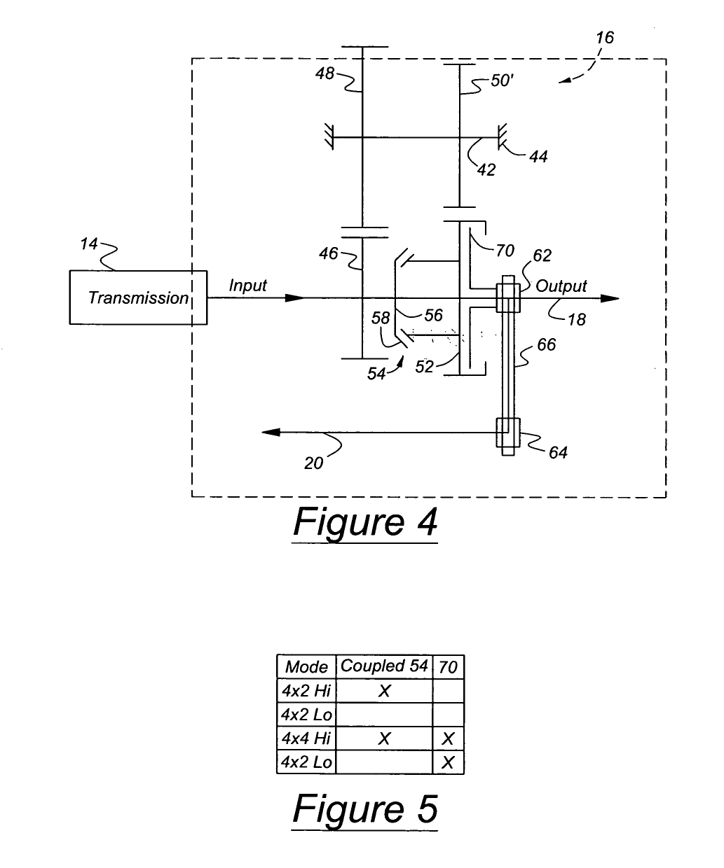

Turning now to FIGS. 4 and 5, where FIG. 4 shows gear 48′ formed integrally with pinion 50′ and that assembly journalled on the outer surface of lay shaft 42. Clutch 60 is deleted from the arrangement of FIG. 4. Aside from these changes, the kinematic arrangements of FIGS. 2 and 4 are identical.

The transfer case produces a high-speed range in the 4×2 mode by engaging coupler 54 and disengaging clutch 70. When coupler 54 is engaged, sleeve 58 moves rightward to engage gear 52. This directly driveably connects input 40 to the first output 18.

Disengaging coupler 54 produces a 4×2 mode, low-speed range. This action causes pinion 46 to underdrive gear 48, and pinion 50 to underdrive gear 52. Therefore, the output 18 is underdriven in relation to the speed of input 40.

Engaging coupler 54 and clutch 70 produces a 4×4 mode, high-speed range. This action causes input 40 to be directly connected through coupler 54 to the first output 18 and gear 52. Clutch 70 driveably connects gear 52 and the first output 18 to the second output 20, through the drive mechanism that includes sprocket wheels 62, 64 and drive chain 66.

Engaging clutch 70 and disengaging coupler 54 produces a 4×4 mode, low-speed range. This underdrives gear 52 and first output 18 in relation to the speed of input 40 through the lay shaft speed reduction mechanism. Clutch 70 driveably connects the second output 20 to the first output 18 and gear 52.

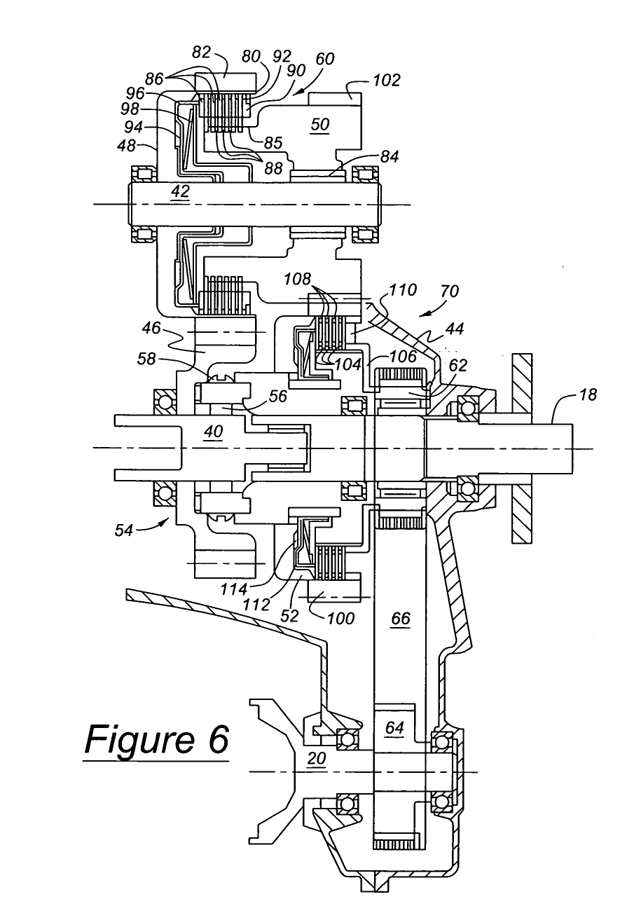

FIG. 6 shows the kinematic arrangement of FIG. 2 as an assembly in cross section. Clutch 60, formed integrally with gear 48, includes a spline surface 80 having axially directed spline teeth formed on the radially inner surface of gear wheel 48, which carries gear teeth 82 on its radially outer surface. Pinion 50, which is supported by a bearing 84 on lay shaft 42, includes a radially outer surface formed with axially directed spline teeth 86. Spacer plates 86 having external teeth on its radially exterior surface, engage the spline teeth 80 formed on gear wheel 48. Interleaved alternately with the spacer plates 86 are friction discs 88, which engage the axially directed spline teeth 85 formed on the outer surface of pinion 50. Located at an axial end of the pack of spacer plates and friction discs is a blocker ring 90, secured to gear 48 against displacement by a snap ring 92.

Gear 48 is formed with a hydraulic cylinder 94, in which a clutch piston 96 moves axially rightward when cylinder 94 is pressurized with hydraulic fluid. A Belleville spring 98 returns piston 96 to the left-hand extremity of cylinder 94 when hydraulic pressure is vented from cylinder 94. When clutch 60 is engaged, it produces a drive connection between gear 48 and pinion 50 by forcing piston against the pack of plates and discs, forcing them into frictional driving contact.

Similarly, clutch 70 is formed integrally with gear wheel 52, which is formed with radially external gear teeth 100 in continuous meshing engagement with the pinion teeth 102 of pinion wheel 50. Clutch 70 includes friction discs 104 splined to a radially outer surface of a ring 106, which is secured to sprocket wheel 62. Interleaved with friction discs 104 are spacer plates 108 splined to the radially inner surface of pinion wheel 52. Located at an axial end of the spacer plate-friction disc pack is a blocker ring 110, secured to gear 52 by a snap ring.

A piston 112, located in a cylinder 114 bounded at least in part by a portion of gear wheel 52, moves axially when hydraulic pressure is applied to cylinder 114. When piston 112 moves rightward, it forces the friction discs and spacer plates 104, 108 into mutually frictional contact producing a drive connection between gear 52 and sprocket wheel 62. A Belleville return spring 116 forces piston 112 out of contact with the friction discs and spacer plates when hydraulic pressure is vented from cylinder 114.

In accordance with the provisions of the patent statutes, the principle and mode of operation of this invention have been explained and illustrated in its preferred embodiment. However, it must be understood that this invention may be practiced otherwise than as specifically explained and illustrated without departing from its spirit or scope.

1. A power transfer mechanism comprising:
an input;
a first output;
a speed reduction drive path driveably connected to the input and first output, for driving the first output at a slower speed than a speed of the input;
a coupler for releaseably connecting the input and first output;
a second output;
a transfer drive continually driveably connecting the first output and second output;
a clutch for releaseably connecting the speed reduction drive path and the first transfer drive.

2. The mechanism of claim 1, wherein the speed reduction drive path further comprises:
a layshaft spaced laterally from the input;
a pinion secured to the input;
a gear supported on the layshaft, and driveably connected to the pinion;
a second pinion supported on the layshaft and secured to the gear; and
a second gear secured to the first output, and driveably connected to the second pinion.

3. The mechanism of claim 1, wherein the second gear includes clutch teeth and the coupler includes:
a hub secured to the input, including spline teeth formed at a radially outer surface; and
a sleeve supported on the hub for displacement relative to the hub, including clutch teeth continually engaged with the spline teeth on the hub and alternately engaged with, and disengaged from the clutch teeth on the second gear as the sleeve moves on the hub.

4. The mechanism of claim 1, further comprising:
a layshaft spaced laterally from the input, and wherein
the input and first output are coaxial; and
the second output is spaced laterally from the first output.

5. The mechanism of claim 1, wherein the transfer drive includes:
a first sprocket wheel rotatably supported on the first output;
a second sprocket wheel secured to the second output; and
a drive chain driveably engaged with the first sprocket wheel and the second sprocket wheel.

6. A power transfer mechanism comprising:
an input;
a first output;
a coupler for releaseably connecting the input and first output;
a second output;
a speed reduction drive path including a pinion secured to the input, a gear journalled on the layshaft and driveably engaged with the pinion, a second pinion journalled on the layshaft, a second gear secured to the first output and driveably engaged with the second pinion, for driving the first output at a lower speed than a speed of the input;
a first clutch for releasably connecting the first gear and the second pinion; and
a second clutch for releasably connecting the second gear and the transfer drive.

7. The mechanism of claim 6, wherein the second gear includes clutch teeth and the coupler includes:
a hub secured to the input, including spline teeth formed at a radially outer surface; and
a sleeve supported on the hub for displacement relative to the hub, including clutch teeth continually engaged with the spline teeth on the hub and alternately engaged with, and disengaged from the clutch teeth on the second gear as the sleeve moves on the hub.

8. The mechanism of claim 6, further comprising:
a layshaft spaced laterally from the input, and wherein
the input and first output are coaxial; and
the second output is spaced laterally from the first output.

9. The mechanism of claim 6, wherein the a transfer includes:
a first sprocket wheel rotatably supported on the first output;
a second sprocket wheel secured to the second output; and
a drive chain driveably engaged with the first sprocket wheel and the second sprocket wheel.

10. The mechanism of claim 6, wherein the first clutch includes:
first friction elements secured to the gear;
second friction elements secured to the second pinion and interleaved with the first friction elements;
a hydraulic cylinder supported on the gear;
a piston located in the cylinder for displacement toward and away from the first and second friction elements, the displacement alternately causing frictional contact among the first and second friction elements, and mutual release of said frictional contact, whereby the gear and first pinion are releasably driveably connected.

11. The mechanism of claim 6, wherein the second clutch includes:
third friction elements secured to the second gear;
fourth friction elements secured to the transfer drive and interleaved with the third friction elements;
a hydraulic cylinder supported on the gear; and
a piston located in the cylinder for displacement toward and away from the third and fourth friction elements, the displacement alternately causing frictional contact among the third and fourth friction elements, and mutual release of said frictional contact, whereby the second gear and transfer drive are releasably driveably connected.
